(19) United States
(12) Patent Application Publication
(10) Pub. No.: US 2012/0330730 A1
(43) Pub. Date: Dec. 27, 2012

(54) Method and Apparatus for Modeling a Client Service Journey

(76) Inventor: Joanne Curry, Baulkham Hills (AU)

(21) Appl. No.: 13/510,278

(22) PCT Filed: Nov. 15, 2010
(86) PCT No.: PCT/AU2010/001521

§ 371 Date: Sep. 5, 2012

Related U.S. Application Data
(60) Provisional application No. 61/261,678, filed on Nov. 16, 2009.

(51) Int. Cl. G06Q 10/00

(52) U.S. Cl. 705/7.39; 705/7.38

(57) ABSTRACT

A method and apparatus is presented for generating an optimized client service journey. The method comprises modeling a scope of a client service, wherein said resulting model is a present client service journey, identifying at least one improvement opportunity, identifying at least one action to implement said improvement opportunity, and transforming using said at least one action, the present client service journey into the optimized client service journey.

### CROSS-REFERENCE TO RELATED APPLICATIONS

This application claims priority to a U.S. Provisional Application having Ser. No. 61/261,678 which was filed on Nov. 16, 2009.

### FIELD OF THE INVENTION

The present invention relates generally to modeling techniques and more particularly to modeling techniques that are applicable to client-service oriented industries, such as, and without limitation, education, travel, and insurance claims. In certain embodiments, the present invention is directed to modeling the provision of health-care services, such as, and without limitation, the provision of midwifery services.

### BACKGROUND OF THE INVENTION

Currently, healthcare process improvement initiatives are using patient journey modeling techniques from non-healthcare domains such as manufacturing, computing, or business. In many cases healthcare improvement projects are using the constructs of these techniques as they were originally proposed and are faced with being unable to capture all of the design features required to deliver high quality patient-centric journeys that are safe, effective, timely, and efficient. This is true of other client-service oriented industries as well. Thus, there is a need for modeling techniques that specifically address the needs of client-service fields.

### SUMMARY OF THE INVENTION

A method for generating an optimized client service journey is presented. The method models a scope of a client service, wherein the resulting model is a present client service journey, identifying at least one improvement opportunity, identifying at least one action to implement the improvement opportunity, and transforming, using the at least one action, the present client service journey into an optimized client service journey.

The method further includes, for each of the plurality of processes, performing the process and updating a pre-configured client service journey to reflect actual performed process, where the updating includes updating the associated measurement. The method further includes providing an alert when one of the at least one measurements exceeds a threshold and transforming the present client service journey into an optimized client service journey, where for the optimized client service journey the one measurement does not exceed the threshold.

An article of manufacture including a computer readable medium comprising computer readable program code disposed therein to generate an optimized client service journey is presented. The computer readable program code includes a series of computer readable program steps to effect: modeling a scope of a client service, where the resulting model is a present client service journey; identifying at least one improvement opportunity, identifying at least one action to implement the improvement opportunity, and transforming, using the at least one action, the present client service journey into an optimized client service journey.

The computer readable program code includes a series of computer readable program steps to effect: modeling a scope of a client service comprising a plurality of processes and at least one measurement associated with each of the plurality of processes, where the resulting model is a present client service journey. The computer readable program code further includes a series of computer readable program steps to effect for each of the plurality of processes: performing the process and updating the present client service journey to reflect the performed process, wherein the updating includes updating the associated measurement. The computer readable program code further includes a series of computer readable program steps to effect providing an alert when one of the at least one measurements exceeds a threshold and transforming the present client service journey into the optimized client service journey, where for the optimized client service journey the one measurement does not exceed the threshold.

A computer program product encoded in a non-transitory computer readable medium and usesable with a programmable computer processor to generate an optimized client service journey is presented. The computer program product comprises computer readable program code which causes the programmable processor to model a scope of a client service, where the resulting model is a present client service journey, to identify at least one improvement opportunity, to identify at least one action to implement the improvement opportunity, and to transform, using the at least one action, the present client service journey into the optimized client service journey.

The computer program product comprises computer readable program code which causes the programmable processor to model a scope of a client service comprising a plurality of processes and at least one measurement associated with each of the plurality of processes, where the resulting model is a present client service journey. For each of the plurality of processes the computer program product further comprises computer readable program code which causes the programmable processor to perform the process and to update the present client service journey to reflect the performed process, where updating includes updating the associated measurement. The computer program product further comprises computer readable program code which causes said programmable processor to provide an alert when one of the at least one measurements exceeds a threshold and to transform the present client service journey into the optimized client service journey, where for the optimized client service journey the one measurement does not exceed the threshold.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a block diagram showing one embodiment of a data storage system according to the present discussion;

FIGS. 2A-C are a block diagram of an exemplary embodiment of a model of a client's service journey according to Applicant's invention;

FIGS. 3A-C are a block diagram of an exemplary embodiment of a model of a client's service journey according to Applicant's invention;

FIG. 4 is an exemplary flowchart depicting Applicant's invention of utilizing a model of a client's service journey; and

FIG. 5 is another exemplary flowchart depicting Applicant's invention of utilizing a model of a client's service journey.

### DETAILED DESCRIPTION

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicant's invention provides a manner of enhanced modeling of a provided service that allows for the identification and implementation of practices to optimize a client's service journey. While discussed in terms of healthcare services, those of ordinary skill in the art will appreciate that Applicant's invention is not so limited and is applicable to any industry providing services to a client.

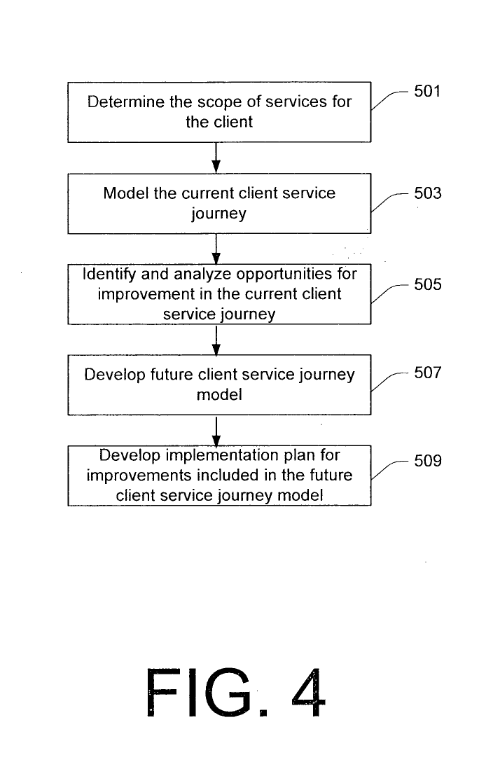

FIG. 4 summarizes Applicant's invention utilizing a model of a client's service journey to improve the services being provided. In the illustrated embodiment of FIG. 4, for a given service offered by a service provider, the scope of the client service journey is determined along with any related service level thresholds, as indicated by block 501. By client service journey, Applicant means the actual processes undertaken by each individual involved in providing the service, including the client, and the resources consumed, both human and physical. Thus, determining the scope of a client service journey entails identifying the steps taken by each individual and the resources utilized in performing those steps.

In certain embodiments, determining the service scope also includes the identification of metrics for use in real-time and perspective evaluations of the client's service journey. In certain embodiments, such metrics are thresholds. In certain embodiments, such metrics are expected or optimal values. By way of example and not limitation, such metrics may include the cost of providing various portions of the service or the entire service, the time allocated for providing various portions of the service or the entire service, the number of times a client must return to the service provider or provide the same information over the course of the provision of the services, or any other related threshold.

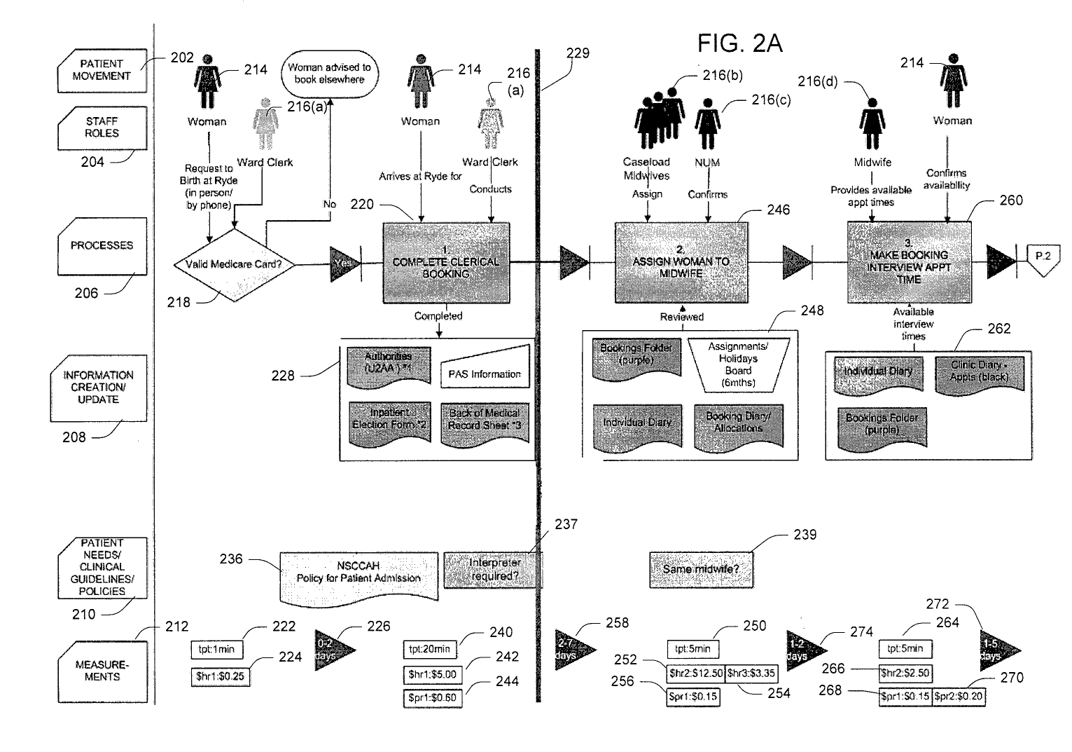

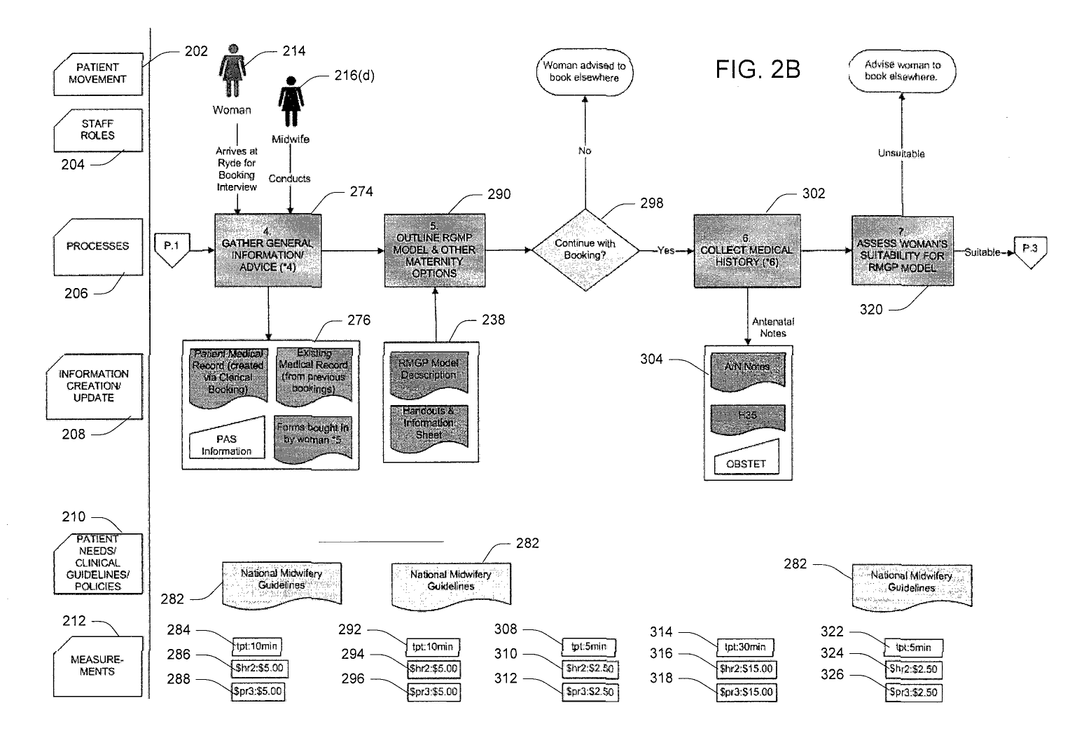

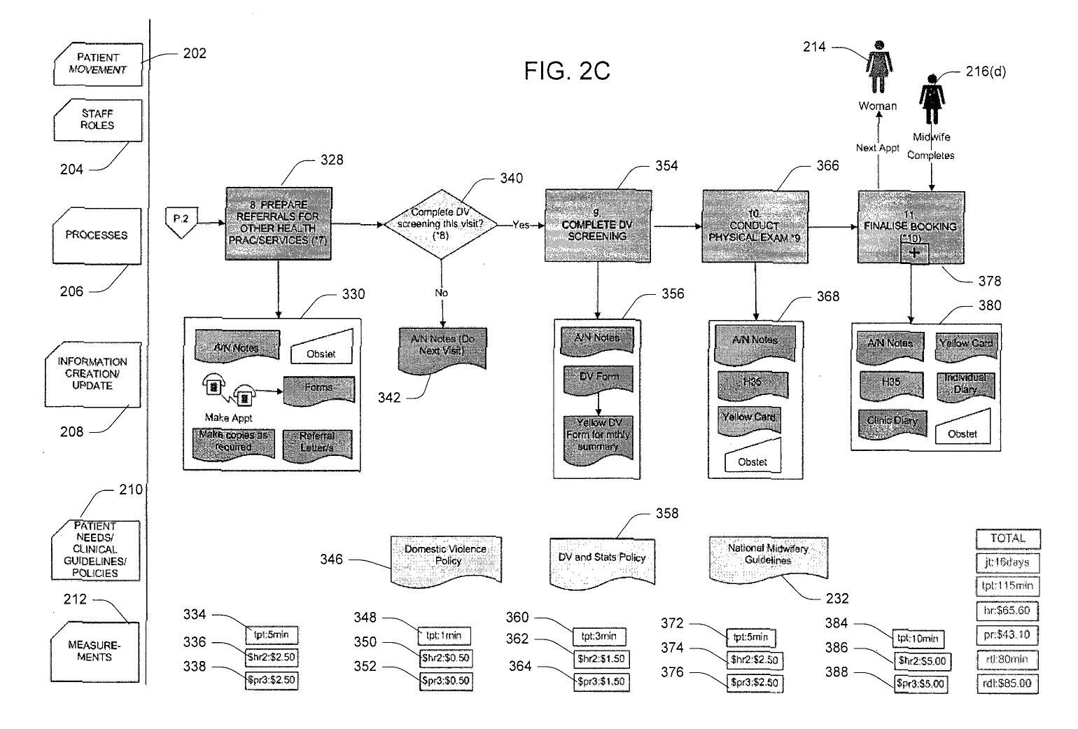

In the illustrative embodiment of FIG. 4, the client's projected service journey is then modeled from a client-centric view, as indicated by block 503. This model of the projected client service journey is sometimes referred in the art as a “current state.” Turning now to FIGS. 2A-C, an exemplary embodiment of a model of a client's service journey according to Applicant's invention is presented. The model presented in FIGS. 2A-C illustrates the patient journey of a maternity patient and is intended to be illustrative rather than limiting. Applicant's invention is equally applicable to provision of additional and other service journeys. Furthermore, the exemplary embodiment of FIGS. 2A-C, details only the first stage of the patient's interaction with the primary care midwifery service—determining whether the patient is a candidate for the services offered by a midwife practice. Applicant's invention can be used to model other aspects of a healthcare journey experienced by a patient as related to the midwife service or select portions thereof.

Turning now to FIG. 2A, model 200 of an exemplary client service journey comprises six (6) distinct layers, layers 202-212, shown to the left of the model. Each layer is mapped left-to-right and are stacked vertically one on top of the other. Furthermore, specific layers can be selected for viewing at a given time to aid with creating and analyzing the patient's projected healthcare journey.

The first layer, layer 202, illustrates the client's physical movement through a service providing system as his/her service journey progresses. Specifically, layer 202 shows when, where, and how many times a client attends the service or is moved as part of their service journey. Thus, in the illustrated example of FIGS. 2A-C, layer 202 represents the number of visits or contacts a patient must make with the clinic to complete a booking interview.

In the depicted embodiment of FIGS. 2A-C a patient is represented by a client icon 214 of a woman. In other embodiments, a client may be represented by a figure of a man. In other embodiments, client icon 214 may be gender neutral. For each process provided in layer 206 where interaction with the patient is required, client icon 214 is depicted above the process in layer 202.

Layer 204 depicts the interactions of staff members along the client's service journey. Taken together, layers 202 and 204 track the interactions of the client and various staff members. Thus, the presence of a number of client icons may indicate that a client is required to repeat processes or provide the same information multiple times. Furthermore, the presence of a number of client icons may indicate that there is a lack of continuity in the service being provided to the client.

In certain embodiments, a staff icon 216 for a staff member may identify the specific staff member interacting with the patient. In such embodiments, staff icon 216 may be gender specific. In such embodiments, staff icon 216 may be color coded, each color designating a specific staff person and/or position. In such embodiments, a name and/or title may be provided below staff icon 216 to identify a specific staff person responsible for executing adjoining process. By way of example and not limitation, staff icon 216(a) of the illustrated example of FIGS. 2A-C is a woman and is labeled “Ward Clerk.” In certain embodiments where multiple staff members having the same position are required to execute an adjoining process, the staff icon may depict multiple people, such as staff icon 216(b). Where the client icon 214 is depicted throughout the model of the client's service journey with a number of different staff icons 216, this may be an indication that there is a lack of responsibility among the staff members for providing the service to the client or that responsibilities are excessively dispersed. Thus, no individual staff member has responsibility for seeing that the service is provided to the client in an efficient or timely manner. This may also be true wherein the staff icons 216 depict a variety of different staff members. Furthermore, an excessive number of staff icons may indicate a lack of continuity in the service being provided to the client.

Layer 206 describes a specific process involved in the client's service journey while layer 208 depicts the information required for the adjoining process and the creation of paperwork or electronic files. In certain embodiments, layers 206 and 208 are modeled using flowcharting symbols. By way of example and not limitation, such flowcharting symbols may include boxes for processes, diamonds for decisions, lightening bolts for communication, process interrupt symbols for blockages or queues, document symbols for papers, forms, or charts, and system symbols for information input or extraction. In certain embodiments, each symbol may be color coded. In such an embodiment, each process block may be blue while each decision diamond is yellow. In certain embodiments, specific processes or information symbols may be color coded, thereby making it easy to identify repeated processes or the excessive use of a given resource. In certain embodiments, delays between processes may be indicated in process layer 206 by a red triangle. In such embodiments, the icon for delay may be related to a measurement in measurement layer 212.

In the illustrated embodiment of FIG. 2A, the client's specific needs and the policies and/or guidelines implicated by the adjoining process are noted in layer 210. By way of example and not limitation, in the present example, the patient's specific needs may include preferred methods of contact, preferred service providers, or religious considerations. Such preferences may be noted each time the preference is implicated by an adjoining process. In the present example, blocks 237 and 239 represent the patient's specific needs by noting whether the patient needs an interpreter or whether the patient is seeing the same midwife, respectively.

Finally, various measurements associated with the adjoining process are noted in layer 212. As will be subsequently discussed, these measurements can later be used to determine the effectiveness of the patient's journey. Layer 212 specifically defines the measurement indicators used to asses the level of patient journey improvement that can be attributed to a change. Actual values are captured for comparison to target values and the identification of variances.

The specific measurements captured in layer 212 will vary depending on the service being provided and the metric being measured. In certain embodiments, indicators are used to measure management and/or outcome of a service. In such embodiments, the indicators may include target process time, actual process time, number of physical resources required, cost of the physical resources, number of human resources required, cost of the human resources, compliance rate, and confidence level. In certain embodiments, where multiple costs of the same type are incurred for a given procedure, the costs may be broken out. Thus, by way of example and not limitation, where a given process requires three (3) clinicians, the cost of each clinician may be separately recorded. In other embodiments, only the total cost for all three (3) clinicians is recorded.

In certain embodiments, additional icons may be used that span layers 202-212 to indicate a formal handover to another service provider or a discontinuity in the provision of the service. In certain such embodiments, a solid line is used to indicate a discontinuity where as a broken line indicates a formal handover. By way of example and not limitation, a discontinuity may occur when there is no formal communication between one service provider to the next. Such knowledge leakage has the potential to increase the risk to patient safety and overall service delivery costs. Alternatively, a formal handover, for example and not limitation, occurs where there is a recognized communication between one service provider to the next.

As previously stated, the illustrated embodiment of FIGS. 2A-C present an example of the healthcare journey of a maternity patient. The illustrated embodiment of FIGS. 2A-C is presented as an example of Applicant's modeling process and should be viewed as illustrative and not limiting. In general, Applicant's model is read top down from left to right, each vertical slice illustrating the relationship of the different layers during the performance of a given process. Once, one vertical slice is understood, the reader moves onto the next vertical slice, with consideration of how the current process is linked to its predecessor. The model can also be read as a number of related vertical slices or it can be sliced horizontally to highlight combinations of different parts of a patient's journey.

Turning to FIG. 2A of the illustrated example, a patient phones or presents at a maternity clinic to gather information about birthing at the clinic. As indicated by layer 202, a client icon 214 represents the patient seeking information from the clinic. On the clinic side, the patient interacts with a ward clerk, represented by staff icon 216(a) in staff roles layer 204. The process layer 206 includes a decision block 218 indicating that before the process can continue the ward clerk must determine if the patient has a valid Medicare card, or other applicable insurance coverage. If the patient does not, the patient is advised to seek an appointment at another clinic. Otherwise the clerical booking, represented by process block 220 can proceed. As indicated in layer 212 by blocks 222 and 224, this first process is projected to take a total of one (1) minute and requires one (1) staff member, the ward clerk, for a total cost of $0.25.

Returning to the top of FIG. 2A, the next vertical slice of the illustrated example is read. Because both the patient and the ward clerk are required for completion of the clerical booking, indicated by process block 220, client icon 214 is seen in layer 202 and staff icon 216(a) is seen in layer 204. If the patient has presented at the clinic and the ward clerk is available the clerical booking can be done right away. If not, the patient must come in at another time. This may lead to a delay of up to 2 days depending on the ward clerk's next available appointment time, as indicated by block 226 in measurement layer 212.

As can be seen by block 228, in layer 208 of the illustrated example, the clerical booking involves the completion of three (3) forms and the creation of a patient administration system (PAS) record. As indicated in layer 210 by block 236, the clerical booking process follows the Policy of Patient Admission. As indicated in layer 212 by blocks 240, 242, and 244, the process is projected to take twenty (20) minutes to complete and require one ward clerk at $15.00/hour using a standard office with a personal computer at $18.00/hour, for a total cost of $5.00 and $0.60, respectively.

As no formal communication about the patient occurs between the ward clerk and the assigning midwives, icon 229 is inserted between blocks 220 and 246. This icon represents a discontinuity of care and indicates that there is a potential risk to the patient. If the patient had communicated something of importance to the Ward Clerk there is no opportunity for the Ward Clerk to transmit this information to the midwives prior to the allocation meeting. Discontinuities of Care have been proven to have the potential to decrease patient safety and increase service costs

Moving to the next vertical slice of the example illustrated in FIG. 2A, the patient would next be assigned to a midwife, as indicated by process block 246. As the patient is not involved in the assignment, layer 202 is empty. However, as the assignment is decided in a meeting of the case managers after a review of all of the clerical books and the schedules of each midwife, a staff icon 216(b) illustrating that multiple case managers are involved is used. Additionally, in the illustrated example of FIG. 2A, staff icon 216(c) indicates that a nurse unit manager (NUM) is also involved in the process and confirms the appointments of each midwife.

Looking at block 248 of layer 208, it can be seen that the allocation information is written in four (4) places: a whiteboard showing details of each midwife's current allocations and expected absences, a bookings book kept on the ward, a bookings folder kept in the clinic, and the allocated midwife's personal diary.

Blocks 250, 252, 254, and 256 indicate that the process of allocating the patient to a midwife is projected to take a total of twenty (20) minutes and require two (2) types of human resources (the case managers and the NUM) and a standard office space. The total human and physical resource cost per allocation is $15.85 and $0.15 respectively.

As can be seen by block 258, also in layer 212, in the present example the process of allocating the patient to a midwife may be delayed by 2-5 days depending on when the clerical booking was done and when the next meeting of the case managers and NUM occurs.

Next, in the illustrated example of FIG. 2A, the allocated midwife calls the patient to make a booking interview appointment, indicated by process block 260 in layer 206. This may take place 1-2 days after the midwife was assigned to the patient's case depending on the midwife's schedule, as captured by block 274. Completion of this process requires both the midwife, denoted by staff icon 216(d) in layer 204, and the patient, denoted by client icon 214. The appointment time agreed upon by the midwife and patient is recorded in the midwife's personal diary, the clinic diary, and the bookings folder, as indicated by block 262. As indicated by blocks 264, 266, 268, and 270, the process of booking the interview appointment is projected to take five (5) minutes to complete and require two physical resources in addition to the midwife: a phone and a standard office space. The process is projected to cost $2.50 in human resources and $0.35 in physical resources.

As indicated by block 272 of the illustrated example of FIG. 2A, the booking interview (blocks 274, 290, 298, 302, 320, 328, 340, 354, 366, and 378, FIG. 2B) is then scheduled 1-5 days later.

Turning to FIG. 2B, in the illustrated example the patient, denoted by client icon 214 in layer 202, would next arrive at the clinic for her booking interview with the midwife, denoted by staff icon 216(d) in layer 204. The booking interview comprises a plurality of steps, the first of which is to collect and review general information about the patient and the services offered by the clinic, as indicated by process block 274. In completing this process, the records created during clerical booking would be reviewed along with the patient's existing medical record and any forms brought in by the patient, as indicated by block 276. This process is conducted in accordance with the National Midwifery Guidelines, denoted by block 282, and is projected to take a total of 10 minutes to complete at a total cost of $10.00, as indicated by blocks 284, 286, and 288.

The midwife would then outline the clinic's maternity process and discusses alternative maternity options with the patient, as indicated by process block 290. During this process the woman is provided several handouts and other relevant literature, as indicated by block 238. The process follows the National Midwifery Guidelines and is projected to take 10 minutes to complete at a cost of $10.00, as indicated by blocks 292, 294, and 296.

Next, in the illustrated example the patient would be asked if she understands the scope of the services offered and if she wishes to continue with the booking, as indicated by process block 298. This process is projected to take 5 minutes and cost a total of $5.00, as indicated by blocks 308, 310, and 312.

If she does not, she is advised to book elsewhere and her healthcare journey ends. If she does, the process continues and the midwife collects a complete medical health history, as indicated by process block 302. As indicated by block 304, the details of the patient's medical history are included in several documents. The process is projected to take 30 minutes and cost a total of $30.00, as indicated by blocks 314, 316, and 318.

Next, the patient's suitability for the birthing model offered by the clinic is assessed, as indicated by process block 320. This process follows the National Midwifery Guidelines, is projected to take 5 minutes to complete and cost a total of $5.00, as indicated by blocks 322, 324, and 326. If the patient is unsuitable then she is referred elsewhere. Otherwise the process depicted in the illustrated example continues as depicted in FIG. 2C.

Turning now to FIG. 2C, if the patient is suitable for the birthing model offered by the clinic, the midwife prepares referrals for pathology and other health services, as indicated by process block 328. This requires the production of several documents and the making of several phone calls as indicated by block 330. The process is projected to take a total of 5 minutes and cost a total of $5.00, as indicated by blocks 334, 336, 338.

Returning to the top of the illustrated example of FIG. 2C, the midwife then makes a decision regarding whether to complete a domestic violence screening this visit according to the domestic violence policy, as indicated by blocks 340 and 346. The domestic violence policy only permits the patient to be screened if she is alone. If the patient is not alone or if her partner gets upset when asked to leave the room, the midwife may postpone the screening until the next visit. If so the notes would be annotated accordingly, as indicated by block 342. The decision of whether or not to complete the domestic violence screening is projected to take one minute and cost a total of $1.00, as indicated by blocks 348, 350, and 352.

If the midwife decides to complete the domestic violence screening this visit, the patient's healthcare journey would continue to process block 354, which indicates that the midwife would then actually perform the domestic violence screening. In doing so several forms are filled out and notes are entered into the patient's charts, as indicated by block 356. The screening is performed in accordance with the domestic violence and area statistics policies, as indicated by block 358 in layer 210. The screening is projected to take three (3) minutes and cost a total of $3.00, as indicated by blocks 360, 362, 364.

Returning again to the top of the illustrated example of FIG. 2C, the midwife would next conduct a physical exam on the patient, as indicated by process block 366 of layer 206. The exam follows the national midwifery guidelines, as indicated by block 232 of layer 210, and uses the patients charts and the midwife's notes, as indicated by block 368 of layer 208. The process is projected to take a total of 5 minutes, as indicated by block 372. The total cost for the exam is projected to be $5.00, as indicated by blocks 374 and 376.

Lastly, the midwife finalizes the booking as indicated by process block 378. Process block 378 includes a plus (“+”) symbol, indicating that finalizing the booking involves sub-processes. Several documents are generated, as indicated by block 380, and the process is projected to take a total of 10 minutes for a cost of $10.00, as indicated by blocks 384, 386, and 388.

As can be seen by reviewing FIGS. 2A-C, the total value added time is projected to be 115 minutes but the time elapsed may be as long as 16 days depending on when the patient attends the service and if staff are available. The total costs of human and physical resources consumed for the patient journey are projected to be $65.60 and $43.35, respectively. The total time and dollar amount that the patient's insurer will reimburse the hospital for each booking interview, however, is 80 minutes and $85.00, respectively. Thus, the booking interview as a whole is projected to be over budget by 35 minutes and $23.95 for a single patient. As will be appreciated by one of ordinary skill in the art, assuming that the procedure for the booking interview is the same for all the women seen at the clinic, this total amount over budget could be significant. By way of example and not limitation, if 240 women undergo a booking interview at the clinic per year, the hospital would be over budget by $5,780.00 annually for just this portion of the service.

Returning to FIG. 4, once the client's projected service journey has been modeled, it is reviewed to identify and analyze any problem areas, as indicated by block 505. In certain embodiments, the identification of problem areas is automated. In such embodiments, the identification may be made by comparing metrics to thresholds. By way of example and not limitation, the time to perform a particular service may be identified as a problem when it is projected to exceed a maximum threshold value. Alternatively, a necessary step in the process of providing the service may be identified as an issue when that step can be circumvented by staff members. Alternatively, a problem may be identified where the process requires the client to provide the same information repeatedly. Alternatively, a problem may be identified where there is a discontinuity of service providers.

By way of example, in the exemplary model depicted in FIGS. 2A-C for a maternity patient several distinct problems areas may be identified. The first being that, within the exemplary service journey depicted, the patient may visit the clinic three (3) times before being assessed for her suitability for the clinic's birthing model. This means that a significant amount of both the midwife's and the patient's time is wasted if the patient is assessed as being unsuitable. Additionally, the entire process, as presented in the illustrated example of FIGS. 2A-C may extend for up to 16 days while the value added time is only 115 minutes. For example, it may be over a week after the patient has completed her clerical booking before she is contacted by a midwife to make a booking interview. Furthermore, the cost of the booking interview is projected to be $23.95 more than what will be reimbursed by the patient's health insurance provider. Additionally, there is a discontinuity of care between ward clerk 216(a)'s meeting with the patient and the midwives allocation meeting, as indicated by line 229. As mentioned, if the patient had communicated something of importance to the Ward Clerk there is no opportunity for the Ward Clerk to transmit this information to the midwives prior to the allocation meeting. Thus, to improve the client service journey, the discontinuity should be removed completely or replaced by a care handover.

By examining the forms used and/or generated, it may be determined that the same information is being collected repeatedly or that the forms are unnecessary. By way of example, in the illustrated example of FIGS. 2A-C, it may be determined that the forms used during the clerical booking process are unsuitable for the clinic's purposes. For example, the ‘Authorities’ form may require four signatures and have two sections that are also in other records and two sections that can be completed by using another form. The ‘Inpatient Election Form’ may also require two signatures and have one section that is not used while the other sections are captured by previous documents. Finally, the ‘Medical Record Sheet’ may require another two signatures and have a total of six sections that are not used. Furthermore, in the illustrated example of FIGS. 2A-C the booking information is duplicated across several mediums. In certain embodiments, the process of examining the forms used and/or generated is automated.

Finally, in the illustrated example model of FIGS. 2A-C the domestic violence screening may not be performed per the domestic violence policy in that the midwife may choose not to complete it during the booking interview if she is uncomfortable doing so for any reason.

Turning again to FIG. 4, the impact of the problems identified are considered and a revised client service journey is developed outlining a more timely, cost effective, and efficient process, as indicated by blocks 505 and 507. Such a revised client service journey model is also known in the art as a “future state.” In certain embodiments, the process of revising a service journey is automated. In such embodiments, the client service journey may be revised based on predetermined metrics.

For the illustrated example of FIGS. 2A-C, one improvement that may be considered is an assessment questionnaire that can be mailed to the patient or completed online which captures details pertinent to the service being provided. Additionally, an information packet could be created and mailed to the patient or provided online, providing information regarding the services the hospital offers and thus negating the need for the woman to attend the hospital for a clerical booking. Furthermore a new patient database may be developed for capturing and appropriately distributing patient information. The database may be linked to other hospital databases such that information can be transferred electronically.

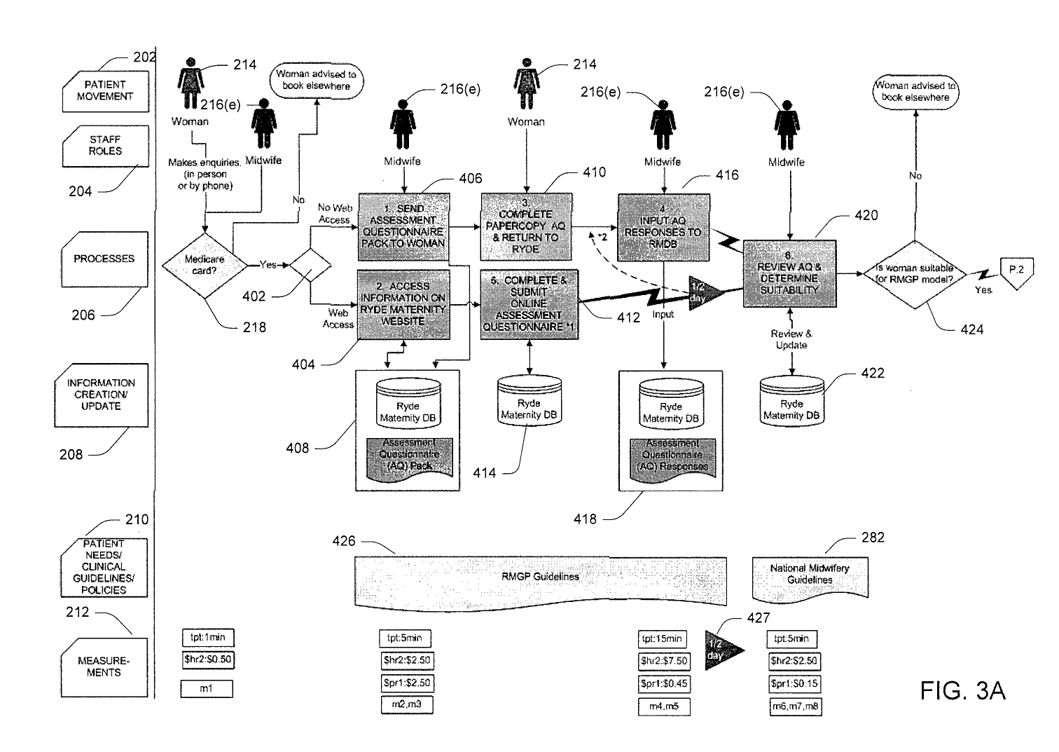

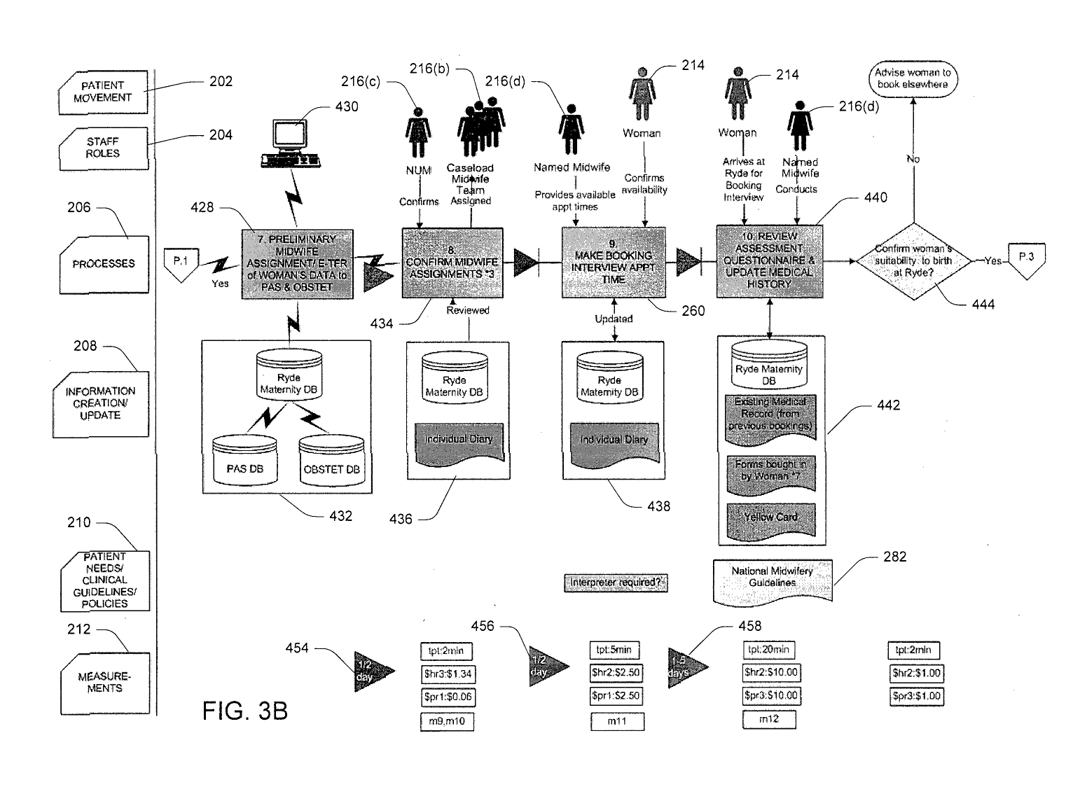

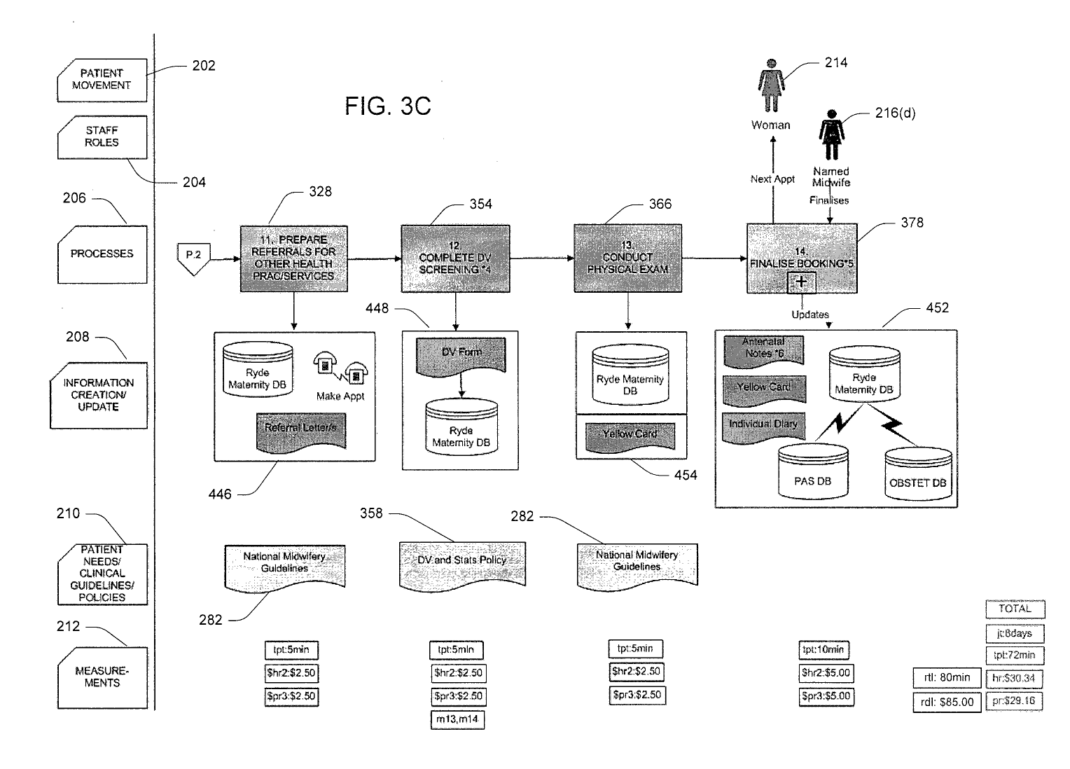

An example of a revised service journey for the maternity patient of FIGS. 2A-C is presented in FIGS. 3A-C. The illustrated embodiment of FIGS. 3A-C is presented as an example of Applicant's invention and should be viewed as illustrative and not limiting.

FIGS. 3A-C represent a revised service journey for a client after the problem areas of the projected service journey of FIGS. 2A-C have been identified and addressed. Specifically, the illustrated example of FIGS. 3A-C depicts a service that is of a higher quality level, maximizes the value of the resources involved, introduces enabling technology, and captures metrics for ongoing monitoring and analysis.

Turning now to the illustrated example of FIG. 3A, a patient would phone or present at a maternity clinic to gather information about birthing at the clinic. As can be seen in layer 202, a client icon 214 represents the patient seeking information from the clinic. On the clinic side, the patient would now interact with a midwife, represented by staff icon 216(e) in staff roles layer 204. The process layer 206 includes a decision block 218 indicating that before the process can continue the midwife would determine if the patient has a valid Medicare card. If the patient does not, the patient would be advise to seek an appointment at another clinic.

If the patient does have a valid Medicare card, she is either given or mailed an information packet having an assessment questionnaire to be completed and returned or directed to a website where she can fill out the assessment, as indicated by process blocks 404, 406, 410, and 412. As indicated by blocks 408, 414, and 418, the patient's responses are centrally stored in a patient database. Thus, the patient would only complete the assessment questionnaire if, after reviewing the hospital information, she still wishes to make a booking with the hospital. Furthermore, the patient is able to complete the assessment questionnaire at her convenience. Additionally, by storing the patient's response in a central database, the information can automatically be propagated onto other forms used in the booking interview process, thereby reducing the number of times the patient has to repeat the same information.

The process of providing the assessment questionnaire and hospital information as well as imputing the responses to the questionnaire is performed in accordance with the clinic's guidelines, as indicated by block 426 of layer 210.

As indicated by block 427, there may be a delay of up to one-half day from the time the paper copy of the assessment questionnaire is received and the time it is input into the patient database (416) by a midwife depending upon the midwife's availability. As indicated by blocks 420, 422, and 424, at this time the midwife, indicated by staff icon 216(e), would assess the information to determine suitability of the patient for the hospital's services. If the patient is unsuitable, she is referred elsewhere. If she is suitable, the patient's journey would continue as described in FIG. 3B.

In certain embodiments, additional metrics may be captured such as how many assessment questionnaires are mailed to patients versus how many are completed online. In certain embodiments, metrics are captured regarding how many new patients are determined to be unsuitable for the hospital's services. In certain embodiments, the reason a new patient is determined to be unsuitable for the hospital's services are captured as metrics in layer 212.

Turning now to the example illustrated in FIG. 3B, when the patient is determined to be suitable for the clinic's services, the patient's information is transferred from the patient database to the databases of those clinic divisions where the patient will be seen, as indicated by block 432. Additionally, a preliminary assignment to a midwife would also be made based on pre-determined business rules and existing midwife bookings. As indicated by block 434 and staff icon 216(c), the NUM is alerted via email to review and approve the assignment of the midwife. As indicated by block 454, there may be a one-half day between the NUM receiving the email and when the NUM approves the assignment due to the NUM's availability. The approval of the assignment is saved in the patient database and in the assigned midwife's diary, as indicated by block 436.

In certain embodiments, additional metrics may be captured such as the number of patients per midwife and the number of estimated births. By way of example and not limitation, these metrics may be used during the midwife's employee review. Furthermore, such metrics could be used to identify that the clinic is in need of additional staff members.

As indicated by block 260 and staff icon 216(d), the allocated midwife then contacts the patient for a booking interview. As indicated by blocks 456 and 458 of layer 212, there may be delays of one-half day between when the midwife is confirmed and when the patient is contacted to making the booking interview appointment and another 1-5 days between when the appointment is made and when it actually occurs depending on the midwife's availability. The appointment would be recorded in the patient database and the midwife's individual diary as indicated by block 438.

As indicated by block 440, when the patient attends the booking appointment, her assessment questionnaire would be reviewed and additional medical history would be recorded, if needed. As indicated by block 442, information stored in the patient database and any existing records would be reviewed and updated as well as any forms brought in by the patient. Upon reviewing the patient's information, the midwife would confirm the patient's suitability for the hospital's services, as indicated by block 444. If the patient is not suitable, the patient is advised to seek services elsewhere. As indicated by block 282, the booking interview is conducted in accordance with the National Midwifery Guidelines.

In certain embodiments, metrics regarding the number of patients declined for services after conducting the booking interview are captured. By way of example and not limitation, such metrics may be used to evaluate the service being provided and to compare the clinic with other clinics offering similar services.

As depicted in the illustrated example in FIG. 3C, if the patient needs referrals, they would now be prepared and the details recorded in the patient's database, as indicated by blocks 328 and 446. Additionally, as indicated by blocks 354 and 448, a domestic violence screening should now be performed and the results recorded. In certain embodiments metrics may be captured regarding the number of domestic violence screenings completed and not completed at the patient's first visit.

As indicated by blocks 366 and 454, the physical exam of the patient would now be conducted by the midwife and recorded in the patient's database. Finally, as indicated by blocks 378 and 452, the booking would be finalized and the appropriate databases updated.

As can be seen by reviewing the example illustrated in FIGS. 3A-C, the total value added time is projected to be 72 minutes and the time elapsed may be as long as 8 days depending on when the patient attends the service and if staff are available. The total costs of human and physical resources consumed for the patient journey are projected to be $30.34 and $29.16, respectively. As stated, the total time and dollar amount the patient's insurer will reimburse the clinic for each booking interview is 80 minutes and $85.00, respectively. Thus, by using the revised patient journey model, the clinic would make a profit of $25.50 per booking interview performed. If, by way of example and not limitation, if 240 women undergo a booking interview at the clinic per year, the clinic would make a profit of $6,120.00 annually.

Returning to FIG. 4, in certain embodiments, the identification of opportunities for improvement, as indicated by block 505, and development of a revised service journey model, as indicated by block 507, is an iterative process. By way of example and not limitation, identification of opportunities for improvement, may include identifying where the process is inefficient, such as where the same information is collected multiple times on different forms. Thus, reducing duplicative data recordings would streamline the process. Alternatively, for example, it might be noted that several visits by the client are required to gather all of the necessary information, where the information could be gathered in a single visit, thus reducing the time spent by both the client and staff.

In certain embodiments embodiment, the processes indicated by blocks 505 and 507 may be repeated until a threshold is met such as, by way of example and not limitation, the particular service can be performed within a given time frame or for a given amount. In certain embodiments, the process indicated by blocks 505 and 507 is automated.

Lastly, once the revised client service journey model has been developed, an implementation plan is established for the improvements included in the client service journey model, as indicated by block 509. The implementation plan is a timeline indicating when specific improvements will be introduced, by whom, and in what areas. In certain embodiments, the revised client service journey model is implemented gradually over time. In such embodiments the work required to initiate a specific improvement may be extensive.

In certain embodiments, the processes described in connection with blocks 501, 503, 505, 507 and 509 are iterative. In such an embodiment, in each iteration one or more improvements are identified until the “ideal” client service journey is achieved.

In certain embodiments, individual processes described in connection with FIG. 4 may be combined, eliminated, or reordered.

In certain embodiments, instructions are encoded in computer readable medium, wherein those instructions are executed by a processor to perform one or more of the blocks 501, 503, 505, 507 and 509 recited in FIG. 4

In yet other embodiments, the invention includes instructions residing in any other computer program product, where those instructions are executed by a computer external to, or internal to, computing device to perform one or more of the blocks 501, 503, 505, 507 and 509 recited in FIG. 4. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

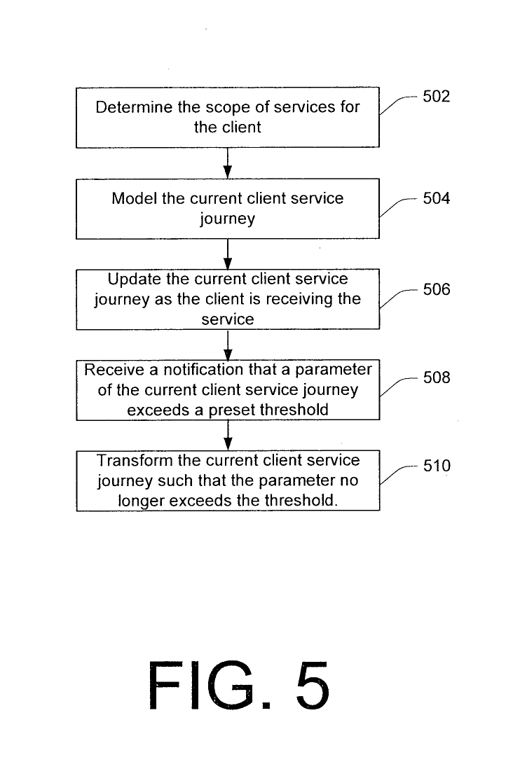

Turning now to FIG. 5, in certain embodiments Applicant's invention presents a model of a client's present service journey as the client moves through the service process. As described in connection with FIG. 4, to begin, the scope of the services to be provided to the client are determined with consideration of any related thresholds and any implementation plans for improvements to the client service journey, as indicated by block 502. As indicated by block 504, the client service journey is then modeled as was described in connection with FIGS. 2A-3C. Thus, the client service journey modeled is the standard or average journey of a client when receiving the service. The model is then updated to reflect the client's specific service journey as the client is receiving the service, as indicated by block 506.

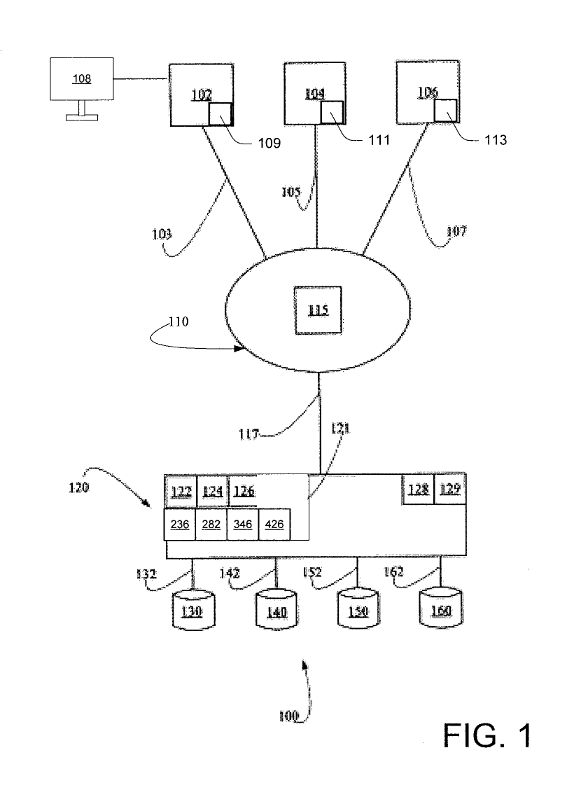

Applicant's dynamic model provides a visually based tool for service providers, allowing each service provider to have timely and contextual information about a client. For example, in certain embodiments a client's service journey is depicted using the icons, avatars, decision blocks, and other information, recited in FIGS. 2A, 2B, and 2C, on visual display device 108 (FIG. 1), wherein visual display device 108 is being used by a non-services provider, such as and without limitation a client services administrator, such as for example and without limitation a health clinic administrator. For example, in certain embodiments a client's service journey is depicted using the icons, avatars, decision blocks, and other information, recited in FIGS. 2A, 2B, and 2C, on visual display device 108 (FIG. 1), wherein visual display device 108 is being used by for example and without limitation a health clinic services provider, such as and without limitation a midwife, a NUM, and the like.

Thus, a service provider can use a model of a client's service journey to make decisions in light of both what processes the client has already been through and what still needs to be done. By way of example and not limitation, in reference to the model of the client service journey presented in FIGS. 3A-C, when reviewing an assessment questionnaire provided by a patient, a midwife may make the decision that an ultrasound is needed before a final determination can be made that the patient is suitable for the services provided by the clinic. By viewing the current model of the patient's journey the midwife can see when the patient's next appointment is and schedule an ultrasound for the same appointment. In doing so, the model of the patient's journey would be updated to reflect that the patient's next appointment will now include an ultrasound. Additionally, the measurements in layer 212 (FIGS. 3A-C) would also be updated to reflect the additional resources that will be consumed.

In certain embodiments, a service provider may automatically receive an alert when a metric captured by the client's service journey exceeds a threshold value, as indicated by block 508. By way of example and not limitation, where the midwife determines that an ultrasound should be preformed during the physical exam portion of the booking interview, that portion of the booking interview may now exceed allotted time and cost allowances. Thus, an alert may be provided.

In certain embodiments, the alert is displayed on visual display device 108 (FIG. 1), wherein visual display device 108 is being used by a health services administrator. In certain embodiments, the alert is displayed on visual display device 108 (FIG. 1), wherein visual display device 108 is being used by the scheduling midwife.

In certain embodiments, the alert is visual. In such an embodiment, color may be used to indicated the acceptability or severity of the variance. By way of example and not limitation, the metrics captured in layer 212 (FIGS. 3A-C) may be green when within an acceptable range, but may be yellow when exceeding a preset threshold. Furthermore, the metrics may be colored red when the threshold is exceeded by a certain percentage. In other embodiments, the alert may be audible. In such an embodiment, a tone may be heard when a model is updated such that a captured metric exceeds a given preset threshold.

In certain embodiments, the alert may be in the form of an automatic email or telephone. By way of example and not limitation, in the example illustrated in FIGS. 3A-C, where the domestic violence screening is not performed, the system may provide an mail alert to an appropriate staff person. The staff person may then be charged with ensuring that the domestic violence screening is performed the next time the patient is at the clinic.

In the illustrated embodiment of FIG. 5, the alert is then used to transform the client's service journey, as indicated by block 510. By way of example and not limitation, where a patient's hospital stay is projected to exceed the time reimbursed by the patient's insurance, the patient's doctor may be alerted. The doctor may then restructure the patient's journey such that the patient's hospital stay does not exceed the time that is reimbursed by the patient's insurance. Alternatively, once alerted, the doctor may discuss the situation with the patient, thereby providing the patient with the opportunity to pay out-of-pocket for the additional care.

In certain embodiments, Applicant's method generates a visual display showing, using the icons, avatars, and other information of FIGS. 2A, 2B, and 2C, instances where the same icon, avatar, document, or data input screen, is utilized multiple times during a client/patient service journey. Such repeated use of the same resources represents an opportunity to streamline the client/patient journey and craft a more cost effective and/or time effective services experience.

In certain embodiments, Applicant's method generates a visual display showing, using the icons, avatars, and other information of FIGS. 2A, 2B, and 2C, instances where the same icon, avatar, document, or data input screen, is utilized multiple times during a client/patient service journey. In these embodiments, the event, icon, avatar, having the most repeated usage is first displayed, followed by a display of the next most repeated event, icon, avatar, document, information input screen/form, and so on. Services administrator can utilize such visual displays to rapidly identify inefficiencies, bottlenecks, and pinch-points, because the instances of repeated usage(s) of the same resource(s) are displayed in the absence of other information. This being the case, Applicant's visual display method uncovers efficiency-enhancement opportunities where such opportunities remain camouflaged and unrecognized using prior art methods.

In certain embodiments, Applicant's invention may further comprise a computing system, such as computing system 100 of FIG. 1. In the illustrated embodiment of FIG. 1, computing system 100 comprises controller 120 and data storage devices 130, 140, 150, and 160. In the illustrated embodiment of FIG. 1, controller 120 communicates with data storage devices 130, 140, 150, and 160, via I/O protocols 132, 142, 152, and 162, respectively. I/O protocols 132, 142, 152, and 162, may comprise any sort of I/O protocol, including without limitation a fibre channel loop, SCSI (Small Computer System Interface), iSCSI (Internet SCSI), SAS (Serial Attach SCSI), Fibre Channel, SCSI over Fibre Channel, Ethernet, Fibre Channel over Ethernet, Infiniband, and SATA (Serial ATA).

By “data storage device,” Applicant means an information storage medium in combination with the hardware, firmware, and/or software, needed to write information to, and read information from, that information storage medium. In certain embodiments, the information storage medium comprises a magnetic information storage medium, such as and without limitation a magnetic disk, magnetic tape, and the like. In certain embodiments, the information storage medium comprises an optical information storage medium, such as and without limitation a CD, DVD (Digital Versatile Disk), HD-DVD (High Definition DVD), BD (Blue-Ray Disk) and the like. In certain embodiments, the information storage medium comprises an electronic information storage medium, such as and without limitation a PROM, EPROM, EEPROM, Flash PROM, compactflash, smartmedia, and the like. In certain embodiments, the information storage medium comprises a holographic information storage medium.

Further in the illustrated embodiment of FIG. 1, Applicant's controller 120 is in communication with computing devices 102, 104, and 106. Computing devices 102, 104, and/or 106, may be used by a patient/client to enter personal information into one or more databases encoded in one or more of data storage devices 130, 140, 150, and/or 160. Computing devices 102, 104, and/or 106, may be used by a staff persons to enter information into one or more databases encoded in one or more of data storage devices 130, 140, 150, and/or 160. Computing devices 102, 104, and/or 106, may be used by administration personnel to review information encoded in one or more databases encoded in one or more of data storage devices 130, 140, 150, and/or 160.

As a general matter, computing devices 102, 104, and 106, each comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald). In certain embodiments, one or more of computing devices 102, 104, and 106, further includes a management module 109, 111, and 113, respectively. In certain embodiments, management module 109, 111, and 113, may include the Policy for Patient Admission 236, National Midwifery Guidelines 282, Domestic Violence Policy 346, and RMGP Guidelines 426.

Management modules 109, 111, and 113, may be implemented as a hardware circuit comprising custom VLSI circuits or gate arrays, off-the-shelf semiconductors such as logic chips, transistors, or other discrete components. Management modules 109, 111, and 113, may also be implemented in programmable hardware devices such as field programmable gate arrays, programmable array logic, programmable logic devices, or the like.

Management modules 109, 111, and 113, may also be implemented in software for execution by various types of processors. An identified module of executable code may, for instance, comprise one or more physical or logical blocks of computer instructions which may, for instance, be organized as an object, procedure, or function. Nevertheless, the executables of an identified management module need not be physically collocated, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the illustrated embodiment of FIG. 1, controller 120 comprises processor 128, metrics 129, non-transitory computer readable medium 121, microcode 122 written to computer readable medium 121, and instructions 124 written to computer readable medium 121, thresholds 126 written to computer readable medium 121, Policy for Patient Admission 236 written to computer readable medium 121, National Midwifery Guidelines 282 written to computer readable medium 121, Domestic Violence Policy 346 written to computer readable medium 121, and RMGP Guidelines 426 written to computer readable medium 121. Processor 128 utilizes microcode 122 to operate controller 120.

In the illustrated embodiment of FIG. 1, computing devices 102, 104, and 106 are connected to fabric 110 utilizing I/O protocols 103, 105, and 107, respectively. I/O protocols 103, 105, and 107, may be any type of I/O protocol; for example, a Fibre Channel (“FC”) loop, a direct attachment to fabric 110 or one or more signal lines used by computing devices 102, 104, and 106, to transfer information to and from fabric 110.

In certain embodiments, fabric 110 includes, for example, one or more FC switches 115. In certain embodiments, those one or more switches 115 comprise one or more conventional router switches. In the illustrated embodiment of FIG. 1, one or more switches 115 interconnect computing devices 102, 104, and 106, to Controller 120 via I/O protocol 117. I/O protocol 117 may comprise any type of I/O interface, for example, a Fibre Channel, Infiniband, Gigabit Ethernet, Ethernet, TCP/IP, iSCSI, SCSI I/O interface or one or more signal lines used by FC switch 115 to transfer information to and from controller 120, and subsequently data storage devices 130, 140, 150, and 160. In other embodiments, one or more computing devices, such as for example and without limitation computing devices 102, 104, and 106, communicate directly with controller 120 using I/O protocols 103, 105, and 107, respectively.

While the preferred embodiments of the present invention have been illustrated in detail, it should be apparent that modifications and adaptations to those embodiments may occur to one skilled in the art without departing from the scope of the present invention.

I claim:

1. A method for generating an optimized client service journey, comprising:
modeling a scope of a client service, wherein said resulting model is a present client service journey;
identifying at least one improvement opportunity;
identifying at least one action to implement said improvement opportunity; and
transforming, using said at least one action, the present client service journey into the optimized client service journey.

2. The method of claim 1, wherein said modeling further comprises identifying:
a plurality of participating individuals, wherein the plurality of participating individuals includes a client;
a plurality of processes, wherein each of said plurality of participating individuals performs at least one of said plurality of processes; and
at least one measurement for each of the plurality of processes.

3. The method of claim 2, wherein said modeling further comprises identifying for each of the plurality of processes:
information required to completed said process; and
information generated by said process.

4. The method of claim 3, wherein said modeling further comprises:
for at least one of the plurality of processes, identifying a client need associated with said process; and
for at least one other of the plurality of processes, identifying a policy associated with said other process.

5. The method of claim 1, further comprising developing an implementation plan for said at least one action.

6. The method of claim 5, further comprising determining at least one metric, wherein said metric is used to identify the at least one improvement opportunity.

7. A method for generating an optimized client service journey, comprising:
modeling a scope of a client service comprising a plurality of processes and at least one measurement associated with each of said plurality of processes, wherein said resulting model is a present client service journey;
for each of the plurality of processes:
performing the process; and
updating the present client service journey to reflect the performed process, wherein said updating includes updating said associated measurement;
providing an alert when one of the at least one measurements exceeds a threshold; and
transforming the present client service journey into the optimized client service journey, wherein for the optimized client service journey the one measurement does not exceed the threshold.

8. The method of claim 7, wherein said modeling further comprises for each of said plurality of processes, identifying a plurality of participating individuals, wherein the plurality of participating individuals includes a client.

9. The method of claim 8, wherein said modeling further comprises for each of the plurality of processes identifying:
information required to completed said process; and
information generated by said process.

10. The method of claim 9, wherein said modeling further comprises:
for at least one of the plurality of processes, identifying a client need associated with said process; and
for at least one other of the plurality of processes, identifying a policy associated with said other process.

11. An article of manufacture comprising a computer readable medium comprising computer readable program code disposed therein to generate an optimized client service journey, the computer readable program code comprising a series of computer readable program steps to effect:
modeling a scope of a client service, wherein said resulting model is a present client service journey;
identifying at least one improvement opportunity;
identifying at least one action to implement said improvement opportunity; and
transforming, using said at least one action, the present client service journey into an optimized client service journey.

12. The article of manufacture of claim 11, wherein said computer readable program code to model the scope of the client service further comprises computer readable program steps to effect identifying:
a plurality of participating individuals, wherein the plurality of participating individuals includes a client;
a plurality of processes, wherein each of said plurality of participating individuals performs at least one of said plurality of processes; and
at least one measurement for each of the plurality of processes.

13. The article of manufacture of claim 12, wherein said computer readable program code to model the scope of the client service further comprises computer readable program steps to effect identifying for each of the plurality of processes:
information required to completed said process; and
information generated by said process.

14. The article of manufacture of claim 13, wherein said computer readable program code to model the scope of the client service further comprises computer readable program steps to effect:
for at least one of the plurality of processes, identifying a client need associated with said process; and
for at least one other of the plurality of processes, identifying a policy associated with said other process.

15. The article of manufacture of claim 11, wherein the computer readable program code further comprises a series of computer readable program steps to effect developing an implementation plan for said at least one action.

16. The article of manufacture of claim 15, wherein said computer readable program code further comprises a series of computer readable program steps to effect determining at least one metric, wherein said metric is used to identify the at least one improvement opportunity.

17. An article of manufacture comprising a computer readable medium comprising computer readable program code disposed therein to generate an optimized client service journey, the computer readable program code comprising a series of computer readable program steps to effect:
modeling a scope of a client service comprising a plurality of processes and at least one measurement associated with each of said plurality of processes, wherein said resulting model is a present client service journey;
for each of the plurality of processes:
performing said process; and
updating the present client service journey to reflect the performed process, wherein said updating includes updating said associated measurement;
providing an alert when one of the at least one measurements exceeds a threshold; and
transforming the present client service journey into the optimized client service journey, wherein for the optimized client service journey the one measurement does not exceed the threshold.

18. The article of manufacture of claim 17, wherein said computer readable program code to model the scope of the client service further comprises computer readable program steps to effect identifying for each of the plurality of processes a plurality of participating individuals, wherein the plurality of participating individuals includes a client.

19. The article of manufacture of claim 18, wherein said computer readable program code to model the scope of the client service further comprises computer readable program steps to effect identifying for each of the plurality of processes:
information required to completed said process; and
information generated by said process.

20. The article of manufacture of claim 19, wherein said computer readable program code to model the scope of the client service further comprises computer readable program steps to effect:
for at least one of the plurality of processes, identifying a client need associated with said process; and
for at least one other of the plurality of processes, identifying a policy associated with said other process.

21. A computer program product encoded in a computer readable medium and usesable with a programmable computer processor to generate an optimized client service journey, the computer program product comprising:
computer readable program code which causes said programmable processor to model a scope of a client service, wherein said resulting model is a present client service journey;
computer readable program code which causes said programmable processor to identify at least one improvement opportunity;
computer readable program code which causes said programmable processor to identify at least one action to implement said improvement opportunity; and
computer readable program code which causes said programmable processor to transform, using said at least one action, the present client service journey into the optimized client service journey.

22. The computer program product of claim 21, wherein said computer readable program code which causes said programmable processor to model further comprises computer readable program code which causes said programmable processor to identify:
a plurality of participating individuals, wherein the plurality of participating individuals includes a client;
a plurality of processes wherein each of said plurality of participating individuals performs at lest one of said plurality of processes; and
at least one measurement for each of the plurality of processes.

23. The computer program product of claim 22, wherein said computer readable program code which causes said programmable processor to model further comprises computer readable program code which causes said programmable processor to identify for each of the plurality of processes:
information required to completed said process; and
information generated by said process.

24. The computer program product of claim 23, wherein said computer readable program code which causes said programmable processor to model further comprises:
computer readable program code which causes said programmable processor to identify for at least one of the plurality of processes a client need associated with said process; and
computer readable program code which causes said programmable processor to identify for at least one other of the plurality of processes a policy associated with said other process.

25. The computer program product of claim 21, further comprising said computer readable program code which causes said programmable processor to develop an implementation plan for said at least one action.

26. The computer program product of claim 25, further comprising computer readable program code which causes said programmable processor to determine at least one metric, wherein said metric is used to identify the at least one improvement opportunity.

27. A computer program product encoded in a computer readable medium and usesable with a programmable computer processor to generate an optimized client service journey, the computer program product comprising:
computer readable program code which causes said programmable processor to model a scope of a client service comprising a plurality of processes and at least one measurement associated with each of said plurality of processes, wherein said resulting model is a present client service journey;
for each of the plurality of processes:
computer readable program code which causes said programmable processor to perform said process; and
computer readable program code which causes said programmable processor to update the present client service journey to reflect the performed process, wherein said updating includes updating said associated measurement;
computer readable program code which causes said programmable processor to provide an alert when one of the at least one measurements exceeds a threshold; and
computer readable program code which causes said programmable processor to transform the present client service journey into the optimized client service journey, wherein for the optimized client service journey the one measurement does not exceed the threshold.

28. The computer program product of claim 27, wherein said computer readable program code which causes said programmable processor to model further comprises computer readable program code which causes said programmable processor to identify for each of said plurality of processes a plurality of participating individuals, wherein the plurality of participating individuals includes a client.

29. The computer program product of claim 28, wherein said computer readable program code which causes said programmable processor to model further comprises computer readable program code which causes said programmable processor to identify for each of the plurality of processes:
information required to completed said process; and
information generated by said process.

30. The computer program product of claim 29, wherein said computer readable program code which causes said programmable processor to model further comprises:
computer readable program code which causes said programmable processor to identify for at least one of the plurality of processes a client need associated with said process; and
computer readable program code which causes said programmable processor to identify for at least one other of the plurality of processes a policy associated with said other process.
